(19) United States
(12) Patent Application Publication
(10) Pub. No.: US 2014/0136873 A1
(43) Pub. Date: May 15, 2014

(54) TRACKING MEMORY BANK UTILITY AND COST FOR INTELLIGENT POWER UP DECISIONS

(71) Applicant: ADVANCED MICRO DEVICES, INC., Sunnyvale, CA (US)

(72) Inventors: Mauricio BRETERNITZ, Austin, TX (US); James M. O'CONNOR, Austin, TX (US); Gabriel H. LOH, Bellevue, WA (US); Yasuko ECKERT, Kirkland, WA (US); Mithuna THOTTETHODI, Bellevue, WA (US); Srilatha MANNE, Portland, OR (US); Bradford M. BECKMANN, Redmond, WA (US)

(73) Assignee: Advanced Micro Devices, Inc., Sunnyvale, CA (US)

(21) Appl. No.: 13/676,805

(22) Filed: Nov. 14, 2012

(51) Int. Cl. G06F 1/28

(52) U.S. Cl. CPC G06F 1/28
USPC 713/340

(57) ABSTRACT

A device receives an indication that a memory bank is to be powered up, and determines, based on receiving the indication, power scores corresponding to powered down memory banks. Each power score corresponds to a power metric associated with powering up a powered down memory bank. The device powers up a selected memory bank based on the plurality of power scores.

### BACKGROUND

A central processing unit stores information in a cache to reduce the average time to access the information. The cache is typically a smaller, faster memory than main memory, such as random access memory. The cache often stores a copy of information stored in the most frequently used main memory locations. The cache may be located closer to the central processing unit than main memory, thus decreasing the amount of time and/or energy needed to access information stored in the cache.

### SUMMARY OF EMBODIMENTS OF AN INVENTION

According to an embodiment of certain aspects of the present invention, a device receives an indication that a memory bank is to be powered up, and determines, based on receiving the indication, power scores corresponding to powered down memory banks. Each power score corresponds to a power metric associated with powering up a powered down memory bank. The device powers up a selected memory bank based on the plurality of power scores.

### BRIEF DESCRIPTION OF THE DRAWINGS

FIG. 1 is a diagram of an overview of an example embodiment described herein;

FIG. 2 is a diagram of example components of a device in which embodiments described herein may be implemented, according to some embodiments;

FIG. 3 is a diagram of example components that may correspond to one or more components illustrated in FIG. 2, according to some embodiments;

FIG. 4 is a diagram of an example process for powering up a memory bank, according to some embodiments;

FIG. 5 is a diagram of an example data structure that stores performance metrics associated with memory banks, according to some embodiments;

FIG. 6 is a diagram of an example data structure that stores conditions that may trigger memory bank power up, according to some embodiments;

FIG. 7 is a diagram of an example data structure that stores power metrics associated with memory banks, according to some embodiments;

FIG. 8 is a diagram of an example data structure that stores characteristics of information stored in memory banks, according to some embodiments

FIG. 9 is a diagram of an example embodiment relating to the example process illustrated in FIG. 4, according to some embodiments; and

FIG. 10 is a diagram of another example embodiment relating to the example process illustrated in FIG. 4, according to some embodiments.

### DETAILED DESCRIPTION OF EXEMPLARY EMBODIMENTS

The following detailed description of example embodiments refers to the accompanying drawings. The same reference numbers in different drawings may identify the same or similar elements.

A processor, such as a central processing unit (“CPU”), may store information in memory banks, such as memory banks included in a CPU cache. In order to save power, the CPU may power down some of the memory banks. However, powering down a memory bank may reduce performance of a system incorporating the CPU and the memory banks. Thus, the CPU may power up one or more memory banks in order to improve system performance. Embodiments described herein assist a CPU in determining when to power up a memory bank, how many memory banks to power up, and/or which memory banks to power up in order to optimize system performance and power consumption.

As used herein, the term “powering up” a memory bank (and other similar terms, such as “power up,” “powered up,” etc.) refers to adjusting a power characteristic of a memory bank so that the memory bank may be utilized to store information. For example, powering up a memory bank may refer to supplying power (e.g., a current, a voltage, etc.) to the memory bank and/or turning the memory bank on. As another example, powering up a memory bank may refer to transitioning the memory bank from a first power consumption state (e.g., off, asleep, standby, hibernation, etc.) to a second power consumption state (e.g., on, awake, ready, etc.), where the amount of power consumed by the memory bank in the second power consumption state is greater than the amount of power consumed by the memory bank in the first power consumption state.

As used herein, the term “powering down” a memory bank (and other similar terms, such as “power down,” “powered down,” etc.) refers to adjusting a power characteristic of a memory bank so that the memory bank may not be utilized to store information. For example, powering down a memory bank may refer to terminating a supply of power (e.g., a current, a voltage, etc.) to the memory bank and/or turning the memory bank off. As another example, powering down a memory bank may refer to transitioning the memory bank from a second power consumption state (e.g., on, awake, ready, etc.) to a first power consumption state (e.g., off, asleep, standby, hibernation, etc.), where the amount of power consumed by the memory bank in the first power consumption state is less than the amount of power consumed by the memory bank in the second power consumption state.

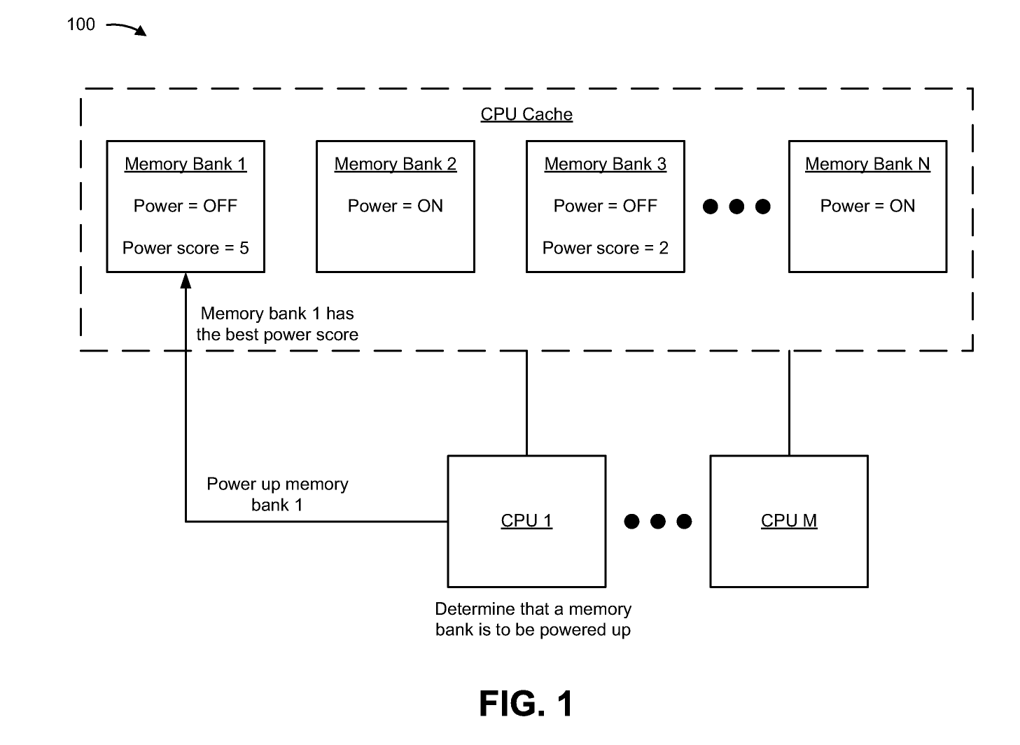

FIG. 1 is a diagram of an overview of an example embodiment 100 described herein. As illustrated in FIG. 1, embodiment 100 includes one or more processors which, in the embodiment described, comprise CPUs (e.g., M CPUs, where M≧1) connected to a CPU cache that includes N memory banks (N>1). In some embodiments, the CPU cache is integrated into (and a part of) the CPU. In other embodiments, the CPU cache is shared by multiple CPUs. Processors other than a CPU could also perform embodiments described herein. Such processors may include, for example, a graphics processing unit (GPU), an accelerated processing unit (APU), an application processor, an application specific integrated circuit (ASIC), a digital signal processor (DSP), or the like.

As shown by embodiment 100, the CPU determines that a memory bank is to be powered up, and calculates a power score for each memory bank that is powered down. In example embodiment 100, memory banks 1 and 3 are powered down, and memory banks 2 and N are powered up. In the example embodiment, memory bank 1 has a power score of five (5), and memory bank 3 has a power score of two (2). The power score indicates a performance improvement and/or a power cost resulting from powering up a memory bank. For example, memory bank 1 is capable of providing greater performance improvement and/or less power cost than memory bank 3, which is reflected in the power score associated with memory banks 1 and 3. As shown by embodiment 100, the CPU determines that memory bank 1 has a better power score than memory bank 3, and powers up memory bank 1 In this way, the CPU can power up the memory bank that provides a better performance improvement and/or a lower power cost when compared to powering up a different memory bank.

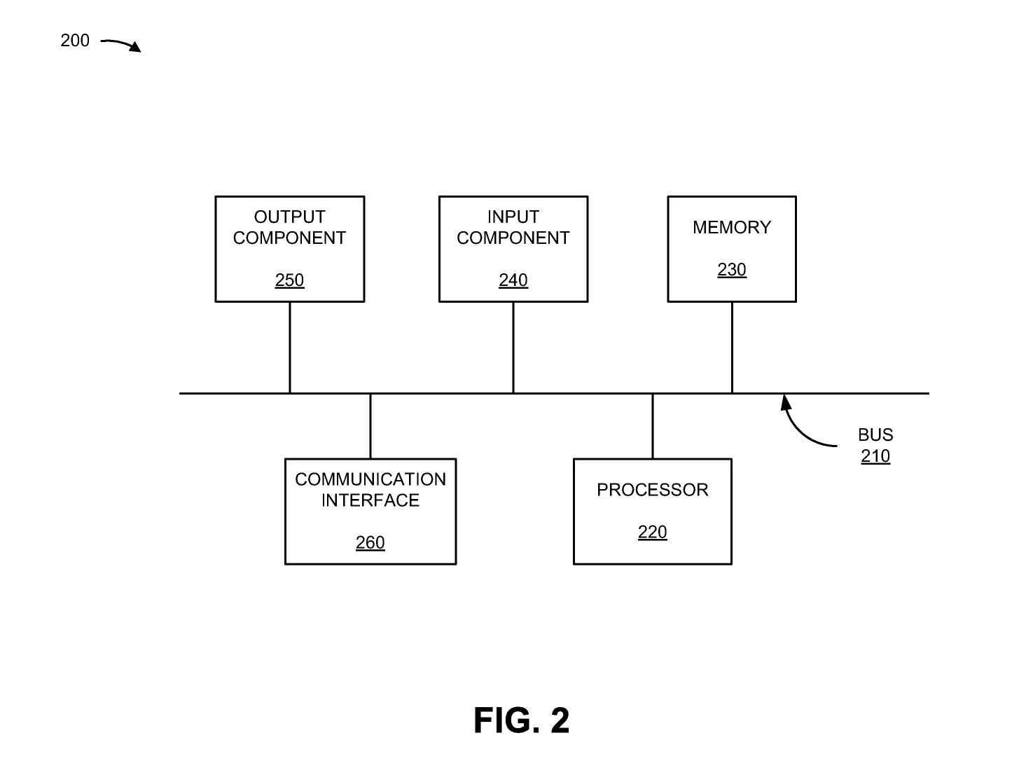

FIG. 2 is a diagram of example components of a device 200 in which embodiments described herein may be implemented. As illustrated in FIG. 2, device 200 includes a bus 210, a processor 220, a memory 230, an input component 240, an output component 250, and a communication interface 260.

Bus 210 includes a path that permits communication among the components of device 200. Processor 220 includes a processing device (e.g., a CPU, a GPU, an APU, an ASIC, a DSP, etc.) that interprets and/or executes instructions. In some embodiments, processor 220 includes one or more processor cores. Additionally, or alternatively, processor 220 includes a combination of processing units.

Memory 230 includes a CPU cache, a scratchpad memory, and/or any type of multi-banked memory that stores information and/or instructions for use by processor 220. Additionally, or alternatively, memory 230 includes random access memory (“RAM”), a read only memory (“ROM”), and/or any type of dynamic or static storage device (e.g., a flash, magnetic, or optical memory) that stores information and/or instructions for use by processor 220.

Input component 240 includes a component that permits a user to input information to device 200 (e.g., a keyboard, a keypad, a mouse, a button, a switch, etc.). Output component 250 includes a component that outputs information from device 200 (e.g., a display, a speaker, one or more light-emitting diodes (“LEDs”), etc.).

Communication interface 260 includes a transceiver-like component, such as a transceiver and/or a separate receiver and transmitter, that enables device 200 to communicate with other devices and/or systems, such as via a wired connection, a wireless connection, or a combination of wired and wireless connections. For example, communication interface 260 may include an Ethernet interface, an optical interface, a coaxial interface, an infrared interface, a radio frequency (“RF”) interface, a universal serial bus (“USB”) interface, or the like.

In some embodiments, device 200 performs various operations described herein. Device 200 may perform these operations in response to processor 220 executing software instructions included in a computer-readable medium, such as memory 230. A computer-readable medium may be defined as a non-transitory memory device. A memory device includes space within a single storage device or space spread across multiple storage devices.

In some embodiments, software instructions are read into memory 230 from another computer-readable medium or from another device via communication interface 260. When executed, software instructions stored in memory 230 cause processor 220 to perform one or more processes that are described herein. Additionally, or alternatively, hardwired circuitry is used in place of or in combination with software instructions to perform one or more processes described herein. Thus, embodiments described herein are not limited to any specific combination of hardware circuitry and software.

The number of components illustrated in FIG. 2 is provided for explanatory purposes. In practice, device 200 may include additional components, fewer components, different components, or differently arranged components than those illustrated in FIG. 2.

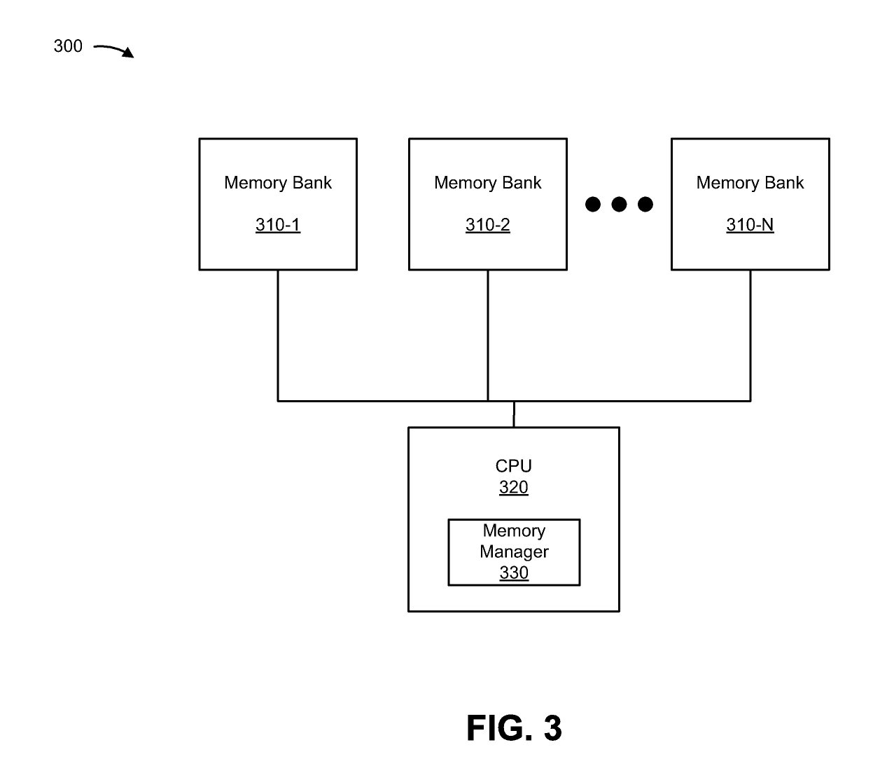

FIG. 3 is a diagram of example components 300 that correspond to processor 220 or memory 230 of FIG. 2, in some embodiments. As illustrated in FIG. 3, components 300 include memory banks 310-1 through 310-N (N>1) (hereinafter referred to collectively as “memory banks 310,” and individually as “memory bank 310”), a CPU 320, and a memory manager 330.

Memory bank 310 includes a storage unit and/or a storage block in which information may be stored. In some embodiments, memory banks 310 corresponds to and/or is incorporated into memory 230. In some embodiments, memory bank 310 is a logical storage unit of a cache and/or a scratchpad memory.

As used herein, the term “block” or “memory block” refers to a sub-division, a section, or a portion of memory bank 310, such as a section that can be read from and/or written to individually. For example, a memory block may refer to a cache line of a cache, a fixed-size block of a scratchpad or other multi-banked memory, etc.

CPU 320 includes a processor, a microprocessor, and/or any processing device and/or processing logic that interprets and executes instructions. In some embodiments, CPU 320 corresponds to processor 220. In some embodiments, CPU 320 and/or another component (e.g., memory manager 330) divides memory (e.g., memory 230, a CPU cache, a scratchpad memory, etc.) into a set of memory banks 310. In some embodiments, CPU 320 includes multiple CPUs, processors, and/or processor cores that share memory banks 310.

Memory manager 330 performs operations associated with powering up a memory bank 310. In some embodiments, memory manager 330 determines that a memory bank 310 is to be powered up, and selects one or more memory banks 310 to power up based on performance metrics and/or power metrics associated with memory banks 310. Additionally, or alternatively, memory manager 330 powers up the selected memory bank 310, and transfers information stored in another memory bank 310 to the selected memory bank 310, for storage. While illustrated as being integrated into (and a part of) CPU 320, memory manager 330 is separate from CPU 320 in some embodiments.

The number of components 300 illustrated in FIG. 3 is provided for explanatory purposes. In practice, components 300 may include additional components, fewer components, different components, or differently arranged components than those illustrated in FIG. 3.

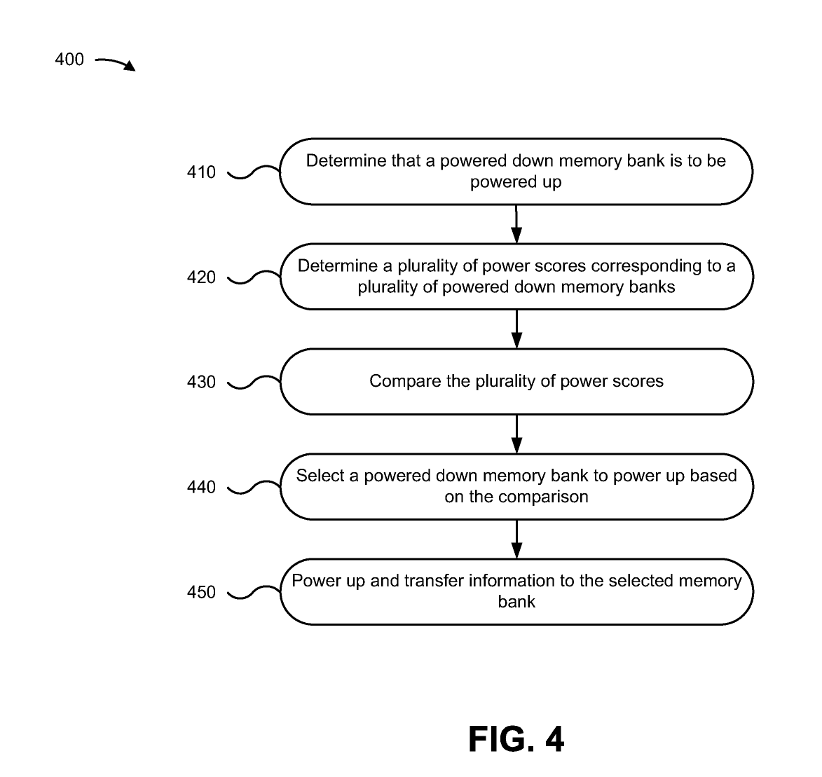

FIG. 4 is a diagram of an example process 400 for powering up a memory bank, according to some embodiments. In some embodiments, one or more process blocks of FIG. 4 are performed by one or more components of CPU 320 and/or memory manager 330. Additionally, or alternatively, one or more process blocks of FIG. 4 are performed by one or more components of another device or a collection of devices including or excluding CPU 320 and/or memory manager 330.

As illustrated in FIG. 4, process 400 includes determining that a powered down memory bank is to be powered up (block 410). In some embodiments, memory manager 330 receives an indication that a memory bank is to be powered up. For example, memory manager 330 may receive the indication when an operating system launches an application and/or a process. Additionally, or alternatively, memory manager 330 may receive the indication when an application and/or a process changes phases, requiring a change in performance of CPU 320 and/or memory banks 310.

In some embodiments, memory manager 330 determines system performance (e.g., performance of memory banks 310, CPU 320, etc.), and determines that a powered down memory bank 310 is to be powered up based on the system performance. In some embodiments, memory manager 330 monitors one or more performance metrics in order to determine system performance. Additionally, memory manager 330 may monitor a performance metric for a memory bank 310, or a set of memory banks 310 (e.g., all memory banks 310, a set of memory banks 310 that are powered up, a set of memory banks 310 that are powered down, etc.).

The performance metric indicates, in some embodiments, a quantity of memory evictions, which refers to a quantity of times that CPU 320 removes information from memory bank 310 in order to create storage space for other information. For example, CPU 320 may receive information from main memory (e.g., random access memory), and may store the received information in memory bank 310. The storage of information in memory bank 310 may cause other information, already stored in memory bank 310, to be removed (or “evicted”) from memory bank 310. For example, this may occur when memory bank 310 lacks capacity to store the information from main memory in an open or available memory block. In some embodiments, the performance metric indicates an amount of information (e.g., in bytes, kilobytes megabytes, etc.) removed from memory bank 310 due to memory evictions.

In some embodiments, the performance metric indicates a quantity of accesses to memory bank 310, which refers to a quantity of times that CPU 320 accesses and/or attempts to access memory bank 310. The quantity of accesses may indicate a quantity of times that CPU 320 reads and/or attempts to read information from memory bank 310, and/or may indicate a quantity of times that CPU 320 writes and/or attempts to write information to memory bank 310.

In other embodiments, the performance metric indicates a quantity of memory misses, which refers to a quantity of times that CPU 320 fails in an attempt to read information from and/or write information to memory bank 310. In some embodiments, the memory misses include conflict misses, which refer to a memory miss that would have been avoided if memory bank 310 had not evicted the information that CPU 320 is attempting to access. Additionally, or alternatively, the memory misses includes capacity misses, which refer to a memory miss that occurs due to a capacity limitation of memory bank 310. Additionally, or alternatively, the memory miss includes a compulsory miss, a cold miss, a mapping miss, a replacement miss, and/or any other type of memory miss.

In still other embodiments, the performance metric indicates a quantity of memory blocks in memory bank 310 that contain dirty information. Dirty information refers to information, stored in memory bank 310, which is to be written to main memory. For example, dirty information may include information that has been written to memory bank 310, but has not yet been written to main memory. Dirty information represents the most up-to-date copy of the information. If the dirty information is evicted from memory bank 310, it must first be written to main memory to ensure that the most up-to-date copy of the information is stored.

The performance metric indicates, in some embodiments, a quantity of memory blocks in memory bank 310 that contain non-native information. Non-native information refers to information, stored in memory bank 310 of CPU 320, that is read by and/or written by another CPU other than CPU 320. Additionally, or alternatively, non-native information refers to information, stored in memory bank 310 of a particular processor core, which is read by and/or written by another processor core other than the particular processor core. For example, a processor may read from and/or write to a memory bank 310, but when that memory bank 310 is powered down, the processor may read from and/or write to a different memory bank 310 (or multiple different memory banks 310). The information read from and/or written to the different memory bank 310 is referred to as non-native information. Additionally, or alternatively, the performance metric indicates a quantity of memory blocks in memory bank 310 that contain native information (e.g., native to a memory bank 310 that stores the information).

In some embodiments, the performance metric indicates a quantity of memory blocks in memory bank 310 that contain shared information. Shared information refers to information that is read by and/or written by more than one CPU 320 and/or more than one processor core. In some embodiments, the performance metric indicates a quantity of memory blocks in memory bank 310 that contain non-shared information. Non-shared information refers to information that is read by and/or written by only one CPU 320 and/or only one processor core.

In other embodiments, the performance metric indicates a quantity of memory blocks in memory bank 310 that contain an instruction and/or read-only information. Additionally, or alternatively, the performance metric indicates a quantity of memory blocks in memory bank 310 that contain a non-instruction and/or non-read-only information (e.g., read/write information).

Alternatives may also account for the system wide performance and power changes that result from powering up or powering down a memory bank 310. For example, powering down a memory bank 310 may result in a greater need to move data between other memory (e.g., a hard drive or a solid state drive) and the remaining powered up memory banks 310. This may result in a loss of performance or increased power consumption. Similarly, powering up a memory bank 310 may reduce the need to use other memories (e.g., hard drive or solid state drives) and thus reduce overall system power consumption and increase overall system performance. Accordingly, embodiments described herein may account for these secondary or system wide effects on performance and/or consumption in the metrics and scores described herein.

In some embodiments, memory manager 330 determines an approximate quantity rather than an exact quantity for the performance metric (e.g., when determining a quantity of blocks containing dirty information, non-native information, instructions, etc.). To accomplish this, memory manager 330 may number and/or identify a set of contiguous blocks from low to high. Memory manager 330 determines the approximate quantity using a pair of block flags. In some embodiments, memory manager 330 flags a “low” block (e.g., the lowest numbered block) containing dirty information, and flags a “high” block (e.g., the highest numbered block) containing dirty information. Memory manager 330 counts the quantity of blocks between the low block and the high block (e.g., including the low block and the high block), to determine the approximate quantity of blocks containing dirty information.

For example, assume that there are ten memory blocks, and blocks two, four, seven, and nine contain dirty information. In some embodiments, memory manager 330 determines an exact quantity of blocks with dirty information (in this case, four blocks). However, memory manage 330 may place a flag on the lowest block containing dirty information (block two) and the highest block containing dirty information (block nine), and determine an approximate quantity of blocks containing dirty information (in this case, blocks two through nine, or eight blocks). Memory manager 330 may use the approximate quantity as the performance metric.

In some embodiments, memory manager 330 uses multiple pairs of high flags and low flags to determine the approximate quantity. In the example above, memory manager 330 may flag block two with a first “low” flag, and may flag block four with a first “high” flag. Similarly, memory manager may flag block seven with a second “low” flag, and may flag block nine with a second “high” flag. Memory manager 330 may determine the approximate quantity based on summing the blocks between blocks two and four (e.g., inclusive), and between blocks seven and nine (e.g., inclusive), to determine an approximate quantity of six blocks.

The performance metric is measured over a time period (e.g., a clock cycle, a bus cycle, a microsecond, a second, etc.), in some embodiments. Additionally, or alternatively, the performance metric is an average performance metric calculated over multiple time periods. Additionally, or alternatively, the performance metric is measured as a ratio (e.g., a rate, a percentage, etc.).

In some embodiments, memory manager 330 determines that a powered down memory bank 310 is to be powered up based on the performance metric satisfying a threshold. Additionally, or alternatively, memory manager 330 determines that a powered down memory bank 310 is to be powered up based on multiple performance metrics each satisfying a threshold.

Memory manager 330 calculates, in some embodiments, a performance score based on multiple performance metrics. Additionally, memory manager 330 weighs performance metrics when determining the performance score. Memory manager 330 may determine that a powered down memory bank 310 is to be powered up based on the performance score satisfying a threshold. In some embodiments, memory manager 330 determines that a powered down memory bank 310 is to be powered up based on a difference in performance scores between multiple memory banks 310 (e.g., a difference in a performance score of a first memory bank 310 and a second memory bank 310, an average difference in performance scores amongst a group of memory banks 310, a difference between a performance score for a memory bank 310 having the highest performance score and a memory bank 310 having the lowest performance score, etc.).

As further shown in FIG. 4, process 400 includes determining a plurality of power scores corresponding to a plurality of powered down memory banks (block 420). In some embodiments, memory manager 330 determines the power scores based on one or more power metrics. Additionally, memory manager 330 monitors a power metric for a memory bank 310, or a set of memory banks 310 (e.g., all memory banks 310, a set of memory banks 310 that are powered up, a set of memory banks 310 that are powered down, etc.). The power metric indicates an amount of power that will be consumed by memory bank 310 and/or CPU 320 (and/or a system including memory bank 310 and/or CPU 320) after memory bank 310 is powered up. In some embodiments, memory manager 330 powers up the memory bank 310 that results in the lowest power consumption after power up.

As still further shown in FIG. 4, process 400 includes comparing the plurality of power scores (block 430), and selecting a powered down memory bank to power up based on the comparison (block 440). In some embodiments, memory manager 330 compares a power score for each memory bank 310 in a set of powered down memory banks 310, and powers up a memory bank 310 with the best (e.g., highest, lowest, closest to a target value, etc.) power score. In some embodiments, memory manager 330 selects multiple powered down memory banks 310, with the best power scores, to power up.

In some embodiments, memory manager 330 determines to power up multiple memory banks 310 based on a performance metric. For example, when powering up memory bank 310 will not satisfy a threshold associated with a performance metric, memory manager 330 determines that multiple memory banks 310 are to be powered up.

As further shown in FIG. 4, process 400 includes powering up and transferring information to the selected memory bank (block 450). In some embodiments, memory manager 330 powers up the selected memory bank 310, and transfers information from other memory banks 310 to the selected memory bank 310.

As will be appreciated, there are a variety of possible embodiments that implement the operations illustrated in FIG. 4. Some of these non-limiting embodiments are described below.

For example, in some embodiments, the power metric indicates an amount of time required to power up memory bank 310. Additionally, or alternatively, the power metric indicates an amount of time required to transfer information from one or more previously powered up memory banks 310 to a memory bank 310 that has been newly powered up by memory manager 330.

Other embodiments may have the power metric indicating a quantity of errors and/or an error rate associated with memory bank 310. For example, the power metric may indicate a quantity of error corrections reported by memory bank 310.

In an alternative embodiment, the power metric indicates an amount of energy and/or power consumed by memory bank 310. The amount of energy and/or power consumed may include an amount of leakage energy and/or an amount of dynamic energy. Leakage energy refers to energy and/or power, consumed by memory bank 310, that does not contribute to the functions of memory bank 310. Dynamic energy refers to energy and/or power, consumed by memory bank 310, when memory bank 310 is performing specific functions. In some embodiments, dynamic energy is determined on a per access basis. For example, dynamic energy may be calculated as an amount of energy consumed by memory bank 310 each time memory bank 310 is accessed (e.g., read from or written to).

The power metric may indicate, in some embodiments, a distance between a powered down memory bank 310 and a component associated with information that will be stored by powered down memory bank 310 after power up. In some embodiments, the distance refers to a length of a wire and/or a circuit that connects powered down memory bank 310 to the component. The distance may refer to an average distance between one or more powered down memory bank 310 and one or more components. In some embodiments, the component includes a powered up memory bank 310 that will transfer information to powered down memory bank 310 after power up. Additionally, or alternatively, the component includes a processor that will access information stored by powered down memory bank 310 after power up.

In some embodiments, the power metric indicates a quantity of times that powered down memory bank 310 has been accessed. For example, the power metric may indicate a quantity of times that instructions included in powered down memory bank 310 have been read or written (e.g., by a processor).

The power metric may be based on a type of information and/or a quantity of information that will be transferred to powered down memory bank 310 after power up. For example, the power metric may be based on an amount of power consumed to transfer information to powered down memory bank 310 after power up. Additionally, or alternatively, the power metric may be based on an amount of power that will be saved by transferring information to powered down memory bank 310 after power up.

In some embodiments, the power metric indicates a quantity of memory blocks containing native and/or non-native information that will be transferred to powered down memory bank 310 after power up (e.g., information that is native and/or non-native to the transferring memory bank 310 and/or information that is native and/or non-native to powered down memory bank 310). In some embodiments, the power metric indicates a quantity of memory blocks containing shared and/or non-shared information that will be transferred to powered down memory bank 310 after power up. In some embodiments, the performance metric indicates a quantity of memory blocks in memory bank 310 that contain an instruction (or a non-instruction) and/or read-only information (or read/write information). Additionally, or alternatively, the performance metric indicates a quantity of memory blocks of a particular type (e.g., an instruction block, a non-instruction block, a read-only block, a read/write block, etc.) that will be transferred after power up.

In another embodiment, the power metric is measured over a time period (e.g., a clock cycle, a bus cycle, a microsecond, a second, etc.). Additionally, or alternatively, the power metric may be an average power metric calculated over multiple time periods. Additionally, or alternatively, the power metric may be measured as a ratio (e.g., a rate, a percentage, etc.).

In yet another embodiment, memory manager 330 calculates the power score based on multiple power metrics. Additionally, or alternatively, memory manager 330 calculates the power score based on an improvement to a performance metric due to powering up memory bank 310. For example, memory manager 330 may calculate a performance metric prior to powering up memory bank 310, and may determine a predicted improvement to the performance metric due to powering up memory bank 310. The power score may be based on the predicted improvement to the performance metric. Additionally, memory manager 330 may weigh power metrics and/or predicted performance metric improvements when determining the power score.

While a series of blocks has been described with regard to FIG. 4, the order of the blocks may be modified in some embodiments. Additionally, or alternatively, non-dependent blocks may be performed in parallel.

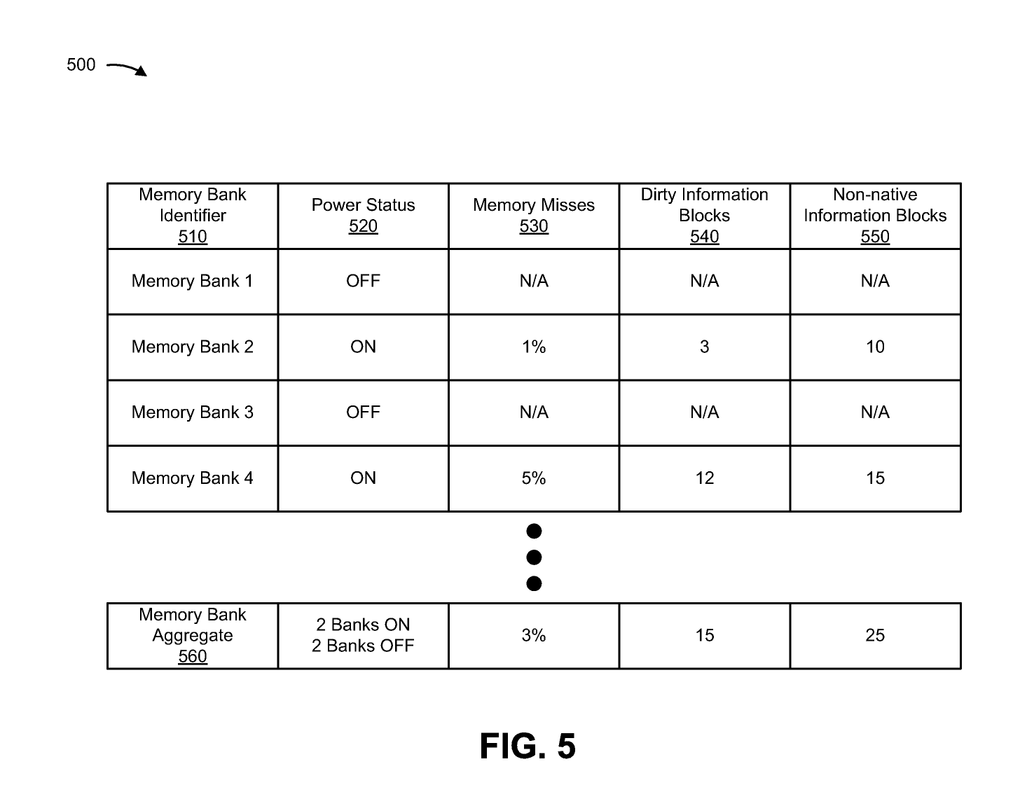

FIG. 5 is a diagram of an example data structure 500 that stores performance metrics associated with memory banks. In some embodiments, data structure 500 is stored in a memory device (e.g., a RAM, a hard disk, etc.), associated with one or more devices and/or components shown in FIGS. 2 and 3. For example, data structure 500 may be stored in memory 230 and/or in a memory register associated with memory bank 310.

Data structure 500 includes a collection of fields, such as a memory bank identifier field 510, a power status field 520, a memory misses field 530, a dirty information blocks field 540, a non-native information blocks field 550, and a memory bank aggregate field 560.

Memory bank identifier field 510 stores information that identifies a memory bank 310. For example, memory bank 310 may be identified by a number, a name, an address, a location, a CPU associated with memory bank 310, etc.

Power status field 520 stores information that identifies a power status of the memory bank 310 identified by memory bank identifier field 510. For example, a power status may be powered down (e.g., “OFF”), powered up (e.g., “ON”), a low performance/power state (e.g., “ASLEEP” or “STANDBY”), etc. In some embodiments, memory manager 330 determines performance metrics only for powered up memory banks 310.

Memory misses field 530 stores information that identifies a quantity of memory misses and/or a memory miss rate of the memory bank 310 identified by memory bank identifier field 510. For example, memory misses field 510 may store a quantity of memory misses, a quantity of memory misses per time period (e.g., a memory miss rate), and/or a ratio of a quantity of memory misses over total quantity of memory access requests (e.g., a memory miss ratio or percentage).

Dirty information blocks field 540 stores information that identifies a quantity of memory blocks, of the memory bank 310 identified by memory bank identifier field 510, that contain dirty information. In some embodiments, the quantity of memory blocks is expressed as a ratio (e.g., a quantity of memory blocks containing dirty information over a total quantity of memory blocks included in memory bank 310).

Non-native information blocks field 550 stores information that identifies a quantity of memory blocks, of the memory bank 310 identified by memory bank identifier field 510, that contain non-native information. In some embodiments, the quantity of memory blocks is expressed as a ratio (e.g., a quantity of memory blocks containing non-native information over a total quantity of memory blocks included in memory bank 310).

Memory bank aggregate field 560 stores information that identifies aggregate performance metrics (e.g., for fields 520-550) for multiple memory banks 310 identified by memory bank identifier field 510. For example, memory bank aggregate field 560 may store an average of multiple performance metrics, a sum of multiple performance metrics, a product of multiple performance metrics, a standard deviation of multiple performance metrics, etc. In some embodiments, memory bank aggregate field 560 stores aggregate information for memory banks 310 based on a status of memory banks 310. For example, memory bank aggregate field 560 may store aggregate information for powered up memory banks 310.

In some embodiments, information associated with a single memory bank 310 is conceptually represented as a row in data structure 500. For example, the second row in data structure 500 corresponds to a memory bank 310 identified as “Memory Bank 2” Memory Bank 2 has a status of “ON” (e.g., powered up), a memory miss rate of one percent (1%), includes three (3) memory blocks with dirty information, and includes ten (10) memory blocks with non-native information.

In some embodiments, information associated with multiple memory banks 310 is conceptually represented as a row in data structure 500. For example, the fifth row in data structure 500 corresponds to an aggregate of memory banks 310 identified as “Memory Bank 2” and “Memory Bank 4” The aggregated memory banks 310 have an average memory miss rate of three percent (3%), contain a sum total of fifteen (15) memory blocks with dirty information, and contain a sum total of twenty-five (25) memory blocks with non-native information.

Data structure 500 includes fields 510-560 for explanatory purposes. In practice, data structure 500 may include additional fields, fewer fields, different fields, or differently arranged fields than those illustrated in FIG. 5. In some embodiments, data structure 500 stores information regarding additional performance metrics, fewer performance metrics, or different performance metrics than discussed in connection with FIG. 5. Additionally, the numbers and/or values illustrated in data structure 500 are provided for explanatory purposes. Furthermore, while data structure 500 is represented as a table with rows and columns, in practice, data structure 500 may include any type of data structure, such as a linked list, a tree, a hash table, a database, or any other type of data structure. In some embodiments, data structure 500 includes information generated by a device and/or component. Additionally, or alternatively, data structure 500 may include information provided from another source, such as information provided by a user, and/or information automatically provided by a device.

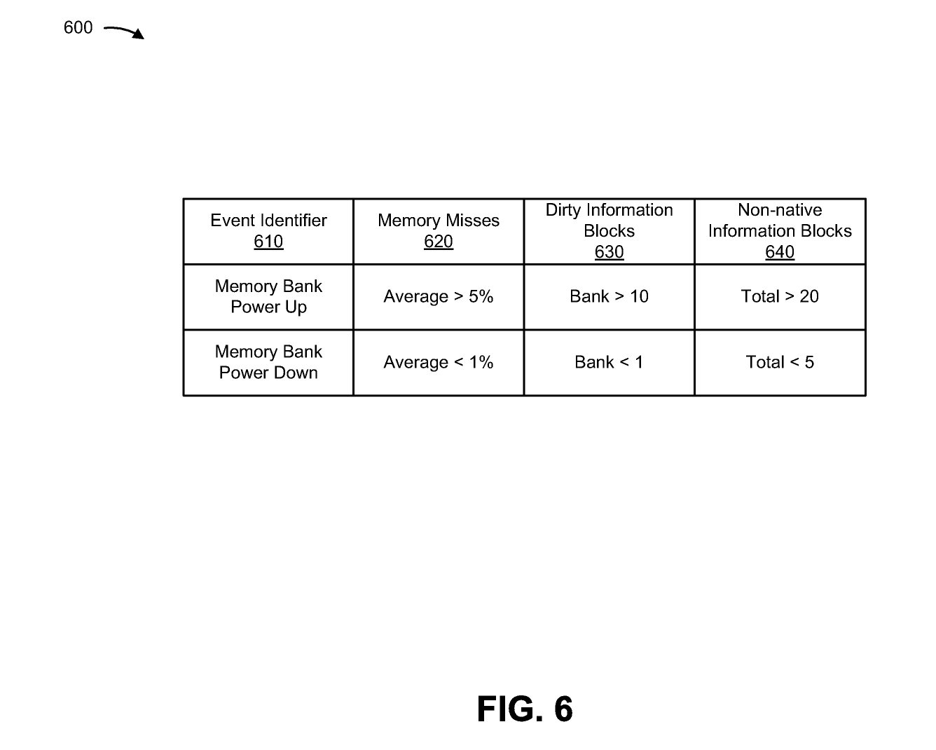

FIG. 6 is a diagram of an example data structure that stores conditions that may trigger memory bank power up. In some embodiments, data structure 600 is stored in a memory device (e.g., a RAM, a hard disk, etc.), associated with one or more devices and/or components shown in FIGS. 2 and 3. For example, data structure 600 may be stored by memory 230 and/or by a memory register associated with memory bank 310.

Data structure 600 includes a collection of fields, such as an event identifier field 610, a memory misses field 620, a dirty information blocks field 630, and a non-native information blocks field 640.

Event identifier field 610 stores information that identifies an event that may be triggered based on conditions identified in fields 620-640. For example, event identifier field 610 may identify a memory bank power up event or a memory bank power down event.

Memory misses field 620 stores information that identifies a condition that triggers the event identified by event identifier field 610. For example, memory bank power up may be triggered when a percentage of memory misses (e.g., a percentage for a single memory bank 310, an aggregate percentage for multiple memory banks 310, etc.) exceeds a threshold of five percent (5%).

Dirty information blocks field 630 stores information that identifies a condition that triggers the event identified by event identifier field 610. For example, memory bank power up may be triggered when a quantity of memory blocks containing dirty information (e.g., a quantity for a single memory bank 310, an aggregate quantity for multiple memory banks 310, etc.) exceeds a threshold of ten (10) blocks.

Non-native information blocks field 640 stores information that identifies a condition that triggers the event identified by event identifier field 610. For example, memory bank power up may be triggered when a quantity of memory blocks containing non-native information (e.g., a quantity for a single memory bank 310, an aggregate quantity for multiple memory banks 310, etc.) exceeds a threshold of twenty (20) blocks.

In some embodiments, the condition identified by a field 620-640 identifies a condition for a single memory bank 310. Alternatively, the condition identified by a field 620-640 identifies a condition for multiple memory banks 310 (e.g., based on information stored by memory bank aggregate field 560). In some embodiments, the event identified by event identifier field 610 is triggered when a single condition identified by a field 620-640 is satisfied. Alternatively, the event identified by event identifier field 610 is triggered when multiple conditions identified by fields 620-640 are satisfied.

Data structure 600 includes fields 610-640 for explanatory purposes. In practice, data structure 600 may include additional fields, fewer fields, different fields, or differently arranged fields than those illustrated in FIG. 6. In some embodiments, data structure 600 stores information regarding additional conditions, fewer conditions, or different conditions than discussed in connection with FIG. 6. Additionally, the numbers and/or values illustrated in data structure 600 are provided for explanatory purposes. Furthermore, while data structure 600 is represented as a table with rows and columns, in practice, data structure 600 may include any type of data structure, such as a linked list, a tree, a hash table, a database, or any other type of data structure. In some embodiments, data structure 600 includes information generated by a device and/or component. Additionally, or alternatively, data structure 600 may include information provided from another source, such as information provided by a user, and/or information automatically provided by a device.

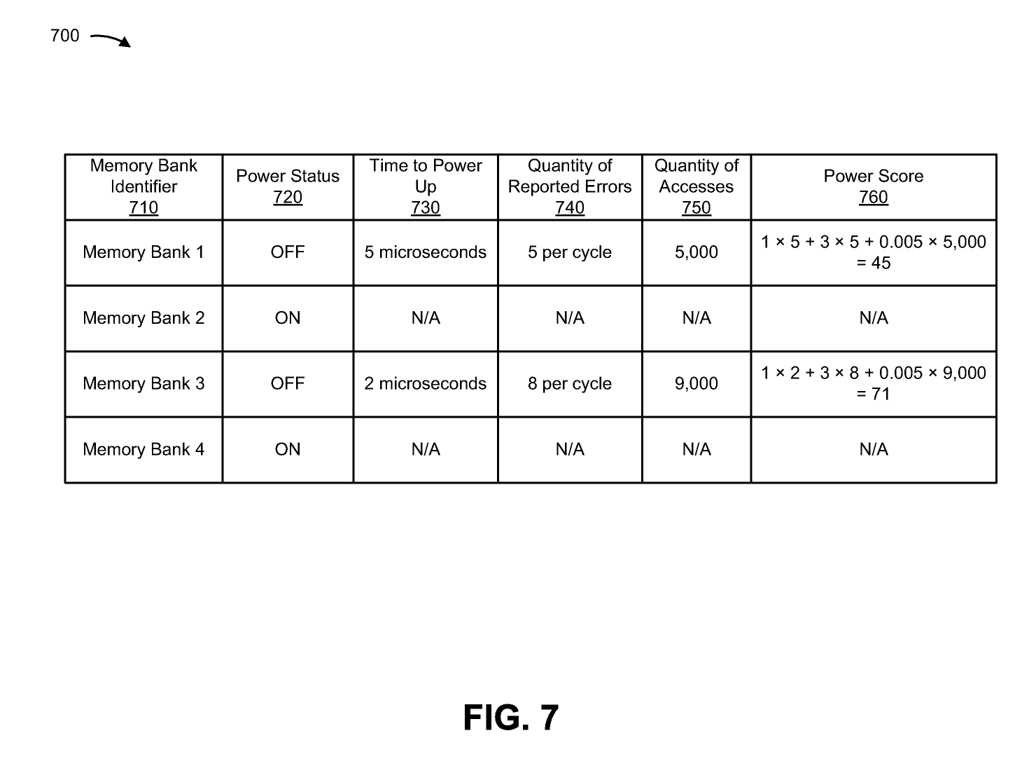

FIG. 7 is a diagram of an example data structure 700 that stores power metrics associated with memory banks. In some embodiments, data structure 700 is stored in a memory device (e.g., a RAM, a hard disk, etc.), associated with one or more devices and/or components shown in FIGS. 2 and 3. For example, data structure 700 may be stored by memory 230 and/or by a memory register associated with memory bank 310.

Data structure 700 includes a collection of fields, such as a memory bank identifier field 710, a power status field 720, a time to power up field 730, a quantity of reported errors field 740, a quantity of accesses field 750, and a power score field 760.

Memory bank identifier field 710 stores information that identifies a memory bank 310. For example, memory bank 310 may be identified by a number, a name, an address, a location, a CPU associated with memory bank 310, etc.

Power status field 720 stores information that identifies a power status of the memory bank 310 identified by memory bank identifier field 710. For example, a power status may be powered down (e.g., “OFF”) or powered up (e.g., “ON”). In some embodiments, memory manager 330 determines power metrics only for powered down memory banks 310.

Time to power up field 730 stores information that identifies an amount of time that it takes memory manager 330 and/or CPU 320 to power up the memory bank 310 identified by memory bank identifier field 710. For example, time to power up field 730 may store an amount of time to power up memory bank 310 in microseconds, clock cycles, bus cycles, or another unit of time.

Quantity of reported errors field 740 stores information that identifies a quantity of errors reported by the memory bank 310 identified by memory bank identifier field 710. In some embodiments, the quantity of reported errors is based on a time period (e.g., a quantity of reported errors per clock cycle).

Quantity of accesses field 750 stores information that identifies a quantity of accesses to the memory bank 310 identified by memory bank identifier field 710. For example, quantity of accesses field 750 may store information that identifies a quantity of a times that a processor has accessed (e.g., read from or written to) memory bank 310.

Power score field 760 stores information that identifies a power score calculated for the memory bank 310 identified by memory bank identifier field 710. In some embodiments, the power score is based on one or more power metrics, such as power metrics identified by fields 730-750. Additionally, or alternatively, memory manager 330 weighs the power metrics when calculating the power score. For example, the power score may be calculated using the following equation:

Power Score=(1×Time to Power Up)+(3×Quantity of Reported Errors)+(0.005×Quantity of Accesses).

Information associated with a single memory bank 310 is conceptually represented as a row in data structure 700. For example, the first row in data structure 700 corresponds to a memory bank 310 identified as “Memory Bank 1” Memory Bank 1 has a status of “OFF” (e.g., powered down), has a time to power up of five (5) microseconds, has a quantity of reported errors of five (5) per clock cycle, has a quantity of accesses of five thousand (5,000), and has a power score of 45, calculated using the power score equation set forth above. In some embodiments, other equations are used to calculate a power score.

Data structure 700 includes fields 710-760 for explanatory purposes. In practice, data structure 700 may include additional fields, fewer fields, different fields, or differently arranged fields than those illustrated in FIG. 7. In some embodiments, data structure 700 stores information regarding additional power metrics and/or predicted performance metric improvements, fewer power metrics and/or predicted performance metric improvements, or different power metrics and/or predicted performance metric improvements than discussed in connection with FIG. 7. Additionally, the numbers and/or values illustrated in data structure 700 are provided for explanatory purposes. Furthermore, while data structure 700 is represented as a table with rows and columns, in practice, data structure 700 may include any type of data structure, such as a linked list, a tree, a hash table, a database, or any other type of data structure. In some embodiments, data structure 700 includes information generated by a device and/or component. Additionally, or alternatively, data structure 700 may include information provided from another source, such as information provided by a user, and/or information automatically provided by a device.

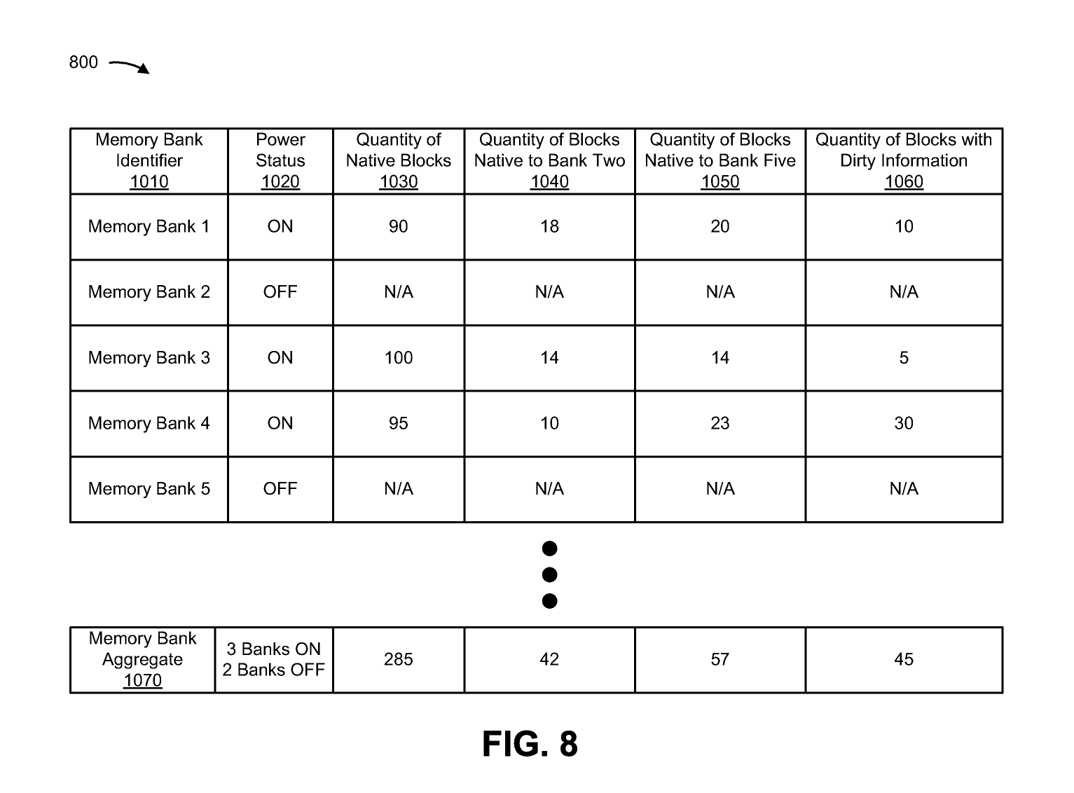

FIG. 8 is a diagram of an example data structure 800 that stores characteristics of information stored in memory banks. In some embodiments, data structure 800 is stored in a memory device (e.g., a RAM, a hard disk, etc.), associated with one or more devices and/or components shown in FIGS. 2 and 3. For example, data structure 800 may be stored by memory 230 and/or by a memory register associated with memory bank 310.

In some embodiments, memory manager 330 uses the characteristics of the information stored in memory banks 310 to determine that a powered down memory bank 310 is to be powered up, to determine how many powered down memory banks 310 to power up, and/or to determine which powered down memory bank(s) 310 to power up. In some embodiments, the power metric and/or the performance metric are based on the characteristics of the information stored in memory banks 310.

Data structure 800 includes a collection of fields, such as a memory bank identifier field 810, a power status field 820, a quantity of native blocks field 830, a quantity of blocks native to bank two field 840, a quantity of blocks native to bank five field 850, a quantity of blocks with dirty information field 860, and a memory bank aggregate field 870.

Quantity of blocks native to bank two field 840 and quantity of blocks native to bank five field 850 are stored in data structure 800 when Memory Bank 2 and Memory Bank 5 are powered down. In some embodiments, one or more other memory banks 310 are powered down, and data structure 800 includes one or more fields that store information regarding a quantity of blocks native to the powered down memory banks 310.

Memory bank identifier field 810 stores information that identifies a memory bank 310. For example, memory bank 310 may be identified by a number, a name, an address, a location, a CPU associated with memory bank 310, etc.

Power status field 820 stores information that identifies a power status of the memory bank 310 identified by memory bank identifier field 810. For example, a power status may be powered down (e.g., “OFF”) or powered up (e.g., “ON”).

Quantity of native blocks field 830 stores information that identifies a quantity of blocks that are native to the memory bank 310 identified by memory bank identifier field 810. For example, a block native to a particular memory bank 310 may refer to a block that would be stored by the particular memory bank 310 when all memory banks 310 are powered up.

Quantity of blocks native to bank two field 840 stores information that identifies a quantity of blocks, stored by the memory bank 310 identified by memory bank identifier field 810, that are native to Memory Bank 2 (e.g., blocks that would be stored by Memory Bank 2 when Memory Bank 2 is powered up and/or all memory banks 310 are powered up, blocks that would be accessed by a processor that would access Memory Bank 2 when Memory Bank 2 is powered up and/or all memory banks 310 are powered up, etc.). Quantity of blocks native to bank five field 850 stores information that identifies a quantity of blocks, stored by the memory bank 310 identified by memory bank identifier field 810, that are native to Memory Bank 5. A powered up memory bank 310 stores information (e.g., in a memory block) that is native to a powered down memory bank 310. In the example illustrated in FIG. 8, Memory Bank 2 and Memory Bank 5 are powered down, and Memory Banks 1, 3, and 4 store information that is native to Memory Banks 2 and 5.

Quantity of blocks with dirty information field 850 stores information that identifies a quantity of blocks, stored by the memory bank 310 identified by memory bank identifier field 810, that contain dirty information (e.g., information that must be written to main memory prior to being transferred to another memory bank 310).

Memory bank aggregate field 870 stores information that identifies aggregate characteristics (e.g., for fields 820-860) for multiple memory banks 310 identified by memory bank identifier field 810. For example, memory bank aggregate field 870 may store an average of multiple characteristics, a sum of multiple characteristics, a product of multiple characteristics, a standard deviation of multiple characteristics, etc. In some embodiments, memory bank aggregate field 870 stores aggregate information for memory banks 310 based on a status of memory banks 310. For example, memory bank aggregate field 870 may store aggregate information for powered up memory banks 310.

In some embodiments, information associated with a single memory bank 310 is conceptually represented as a row in data structure 800. For example, the first row in data structure 800 corresponds to a memory bank identified as “Memory Bank 1” Memory Bank 1 has a status of “ON” (e.g., powered up), contains ninety (90) native memory blocks, contains eighteen (18) memory blocks that are native to Memory Bank 2, contains twenty (20) memory blocks that are native to Memory Bank 5, and contains ten (10) memory blocks with dirty information.

Additionally, or alternatively, information associated with multiple memory banks 310 is conceptually represented as a row in data structure 800. For example, the sixth row in data structure 800 corresponds to an aggregate of memory banks 310 identified by memory bank identifier field 810. The sixth row in data structure 800 indicates that three (3) memory banks 310 are powered up (“ON”), two (2) memory banks are powered down (“OFF”), the sum of native blocks is two-hundred-eight-five (285), the sum of blocks native to Memory Bank 2 is forty-two (42), the sum of blocks native to Memory Bank 5 is fifty-seven (57), and the sum of blocks containing dirty information is forty-five (45).

In some embodiments, memory manager 330 determines that a memory bank 310 is to be powered up when the characteristic of the information stored in memory bank 310 satisfies a threshold. For example, memory manager 330 may determine that a memory bank 310 is to be powered up when a single memory bank 310 contains more than twenty-five (25) blocks with dirty information, and/or when a set of memory banks 310 contains an aggregate (e.g., a sum, a product, an average, etc.) of more than forty (40) blocks with dirty information.

In another embodiment, memory manager 330 determines a quantity of memory banks 310 to power up based on the characteristic, such as a quantity of blocks to be transferred upon power up, a quantity of non-native blocks (e.g., a total quantity or a quantity stored in a particular memory bank 310), a quantity of dirty blocks, etc. In some embodiments, memory manager 330 compares the characteristic to a threshold to determine how many and/or which memory banks 310 to power up. For example, memory manager 330 may compare a quantity of memory blocks, to be transferred upon power up, to a threshold. For example, a threshold of fifty (50) permissible transferred blocks would allow memory manager 330 to power up Memory Bank 2 (which would receive 42 transferred blocks). A threshold of sixty (60) permissible transferred blocks would allow memory manager 330 to power up Memory Bank 2 (which would receive 42 transferred blocks) or Memory Bank 5 (which would receive 57 transferred blocks), but not both. A threshold of one-hundred (100) permissible transferred blocks would allow memory manager 330 to power up Memory Bank 2, Memory Bank 5, or both Memory Banks 2 and 5 (which would result in a total of 99 transferred blocks).

In yet another embodiment, memory manager 330 determines how many and/or which memory banks 310 to power up based on balancing the characteristic across multiple memory banks 310. For example, memory bank 330 may determine how many and/or which memory banks 310 based on powering up memory banks 310 that would result in minimizing a difference (e.g., a predicted difference) in a quantity of non-native blocks (or dirty blocks, instruction blocks, etc.) stored in a set of memory banks 310.

Memory manager 330 may determine which memory bank 310 to power up based on a comparison of the characteristics. For example, memory manager 330 may power up Memory Bank 5 instead of Memory Bank 2 because powering up Memory Bank 5 frees up more blocks (57 blocks) from the other memory banks 310 than powering up Memory Bank 2 (42 blocks). As another example, memory manager 330 may power up Memory Bank 2 instead of Memory Bank 5 because powering up Memory Bank 2 requires less power to transfer 42 blocks instead of the 57 blocks that would be transferred by powering up Memory Bank 5.

In some embodiments, memory manager 330 determines which memory bank 310 to power up based on optimization criteria specified by a user. As used herein, “optimizing” may refer to minimizing, maximizing, or coming closest to a target value. For example, the optimization criteria may include optimizing a power consumption (e.g., of memory banks 310, CPU 320, and/or a system including memory banks 310 and/or CPU 320), optimizing performance, optimizing a quantity of transferred blocks, optimizing a quantity of non-native blocks stored by a set of memory banks 310, optimizing a transfer of blocks of a particular type (e.g., an instruction block, a native block, a non-native block, a shared block, a non-shared block, a dirty block, a non-dirty block, etc.), optimizing a particular power metric, optimizing a set of power metrics, optimizing a power score, optimizing a particular performance metric, optimizing a set of performance metrics, optimizing a performance score, optimizing a quantity of transfers to a particular memory bank 310, optimizing a quantity of transfers to a set of memory banks 310, optimizing a quantity of freed-up blocks (e.g., memory blocks containing information in memory bank 310 before a transfer that have been freed up to store other information after a transfer), and/or any combination of these or other optimization criteria.

The particular characteristics, thresholds, memory banks, memory block types, and optimization criteria discussed herein in connection with FIG. 8 are provided as an example. In some embodiments, memory manager 330 uses different characteristics, thresholds, memory banks, memory block types, and optimization criteria than discussed herein in connection with in FIG. 8, when determining that a memory bank 310 is to be powered up, how many memory banks 310 to power up, and/or which memory bank(s) 310 to power up. In some embodiments, memory manager 330 receives input from a user to determine the characteristics, thresholds, memory banks, memory block types, and optimization criteria.

Data structure 800 includes fields 810-870 for explanatory purposes. In practice, data structure 800 may include additional fields, fewer fields, different fields, or differently arranged fields than those illustrated in FIG. 8. Additionally, the numbers and/or values illustrated in data structure 800 are provided for explanatory purposes. Furthermore, while data structure 800 is represented as a table with rows and columns, in practice, data structure 800 may include any type of data structure, such as a linked list, a tree, a hash table, a database, or any other type of data structure. In some embodiments, data structure 800 includes information generated by a device and/or component. Additionally, or alternatively, data structure 800 may include information provided from another source, such as information provided by a user, and/or information automatically provided by a device.

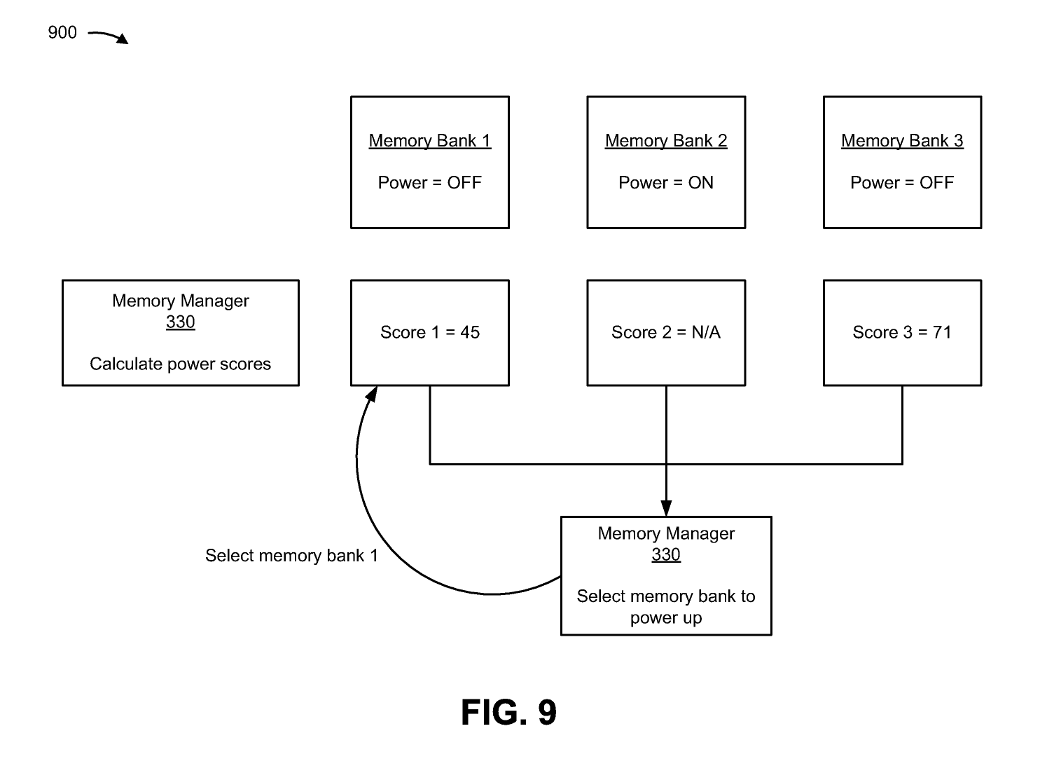

FIG. 9 is a diagram of an example embodiment 900 relating to example process 400, illustrated in FIG. 4. FIG. 9 illustrates embodiment 900 where memory manager 330 powers up a memory bank 310 with the best power score.

As shown by embodiment 900, memory manager 330 calculates a power score for multiple powered down memory banks 310. For example, Memory Bank 1 and Memory Bank 3 are powered down, and memory manager 330 calculates a power score for Memory Bank 1 and Memory Bank 3. In embodiment 900, memory manager 330 calculates a power score of forty-five (45) for Memory Bank 1, and a power score of seventy-one (71) for Memory Bank 3 (see power score field 760 of FIG. 7 for an example of how memory manager 330 may calculate the power scores). In embodiment 900, a lower power score is more desirable than a higher power score. Thus, Memory Bank 1 (45) has a better power score than Memory Bank 3 (71). Memory manager 330 selects Memory Bank 1 for power up based on comparing the power scores of Memory Banks 1 and 3.

The information shown in FIG. 9, such as the quantity of memory banks 310, the status of each memory bank 310, and the power scores, are provided as an example. Some embodiments include additional information, less information, or different information than illustrated in FIG. 9. In some embodiments, memory manager 330 receives input from a user to determine the power score equation.

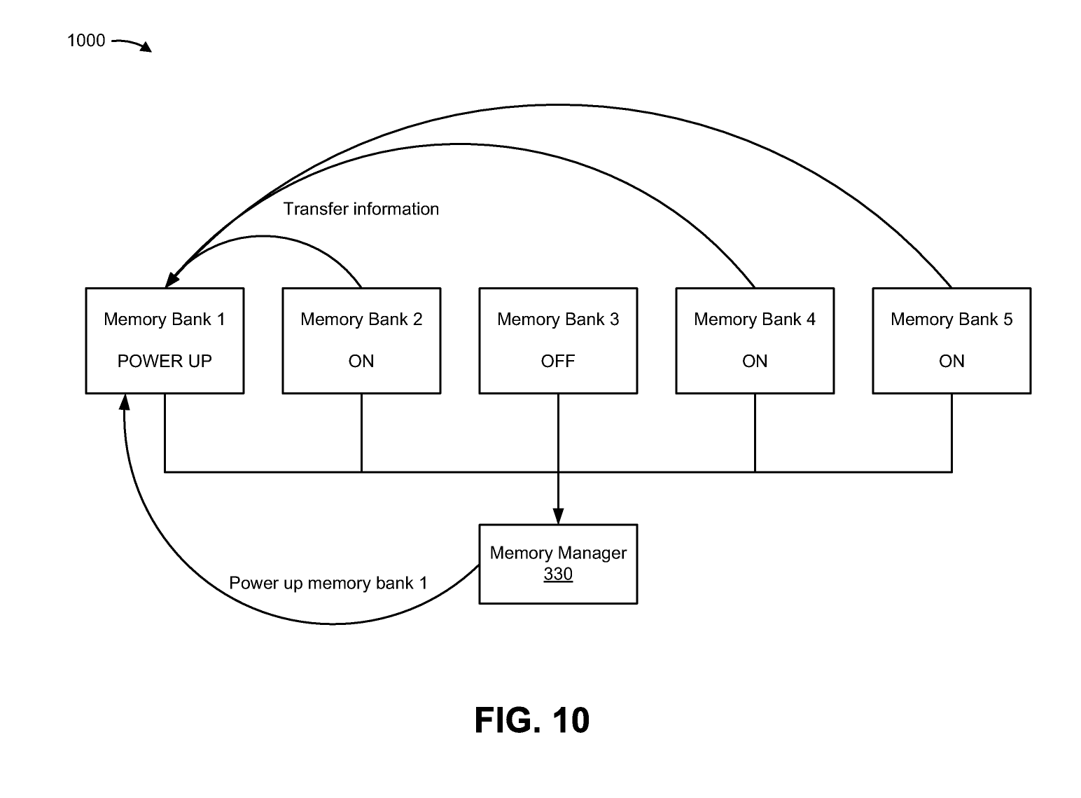

FIG. 10 is a diagram of another example embodiment 1000 relating to process 400, illustrated in FIG. 4. FIG. 10 illustrates embodiment 1000 where memory manager 330 powers up a memory bank 310 and transfers information from other memory banks 310 to the powered up memory bank 310.

As shown by embodiment 1000, memory manager 330 powers up Memory Bank 1 based on Memory Bank 1 having the best power score (e.g., a better power score than Memory Bank 3, which is illustrated as powered down, or “OFF”). In embodiment 1000, Memory Banks 2, 4, and 5 contain information to be transferred to Memory Bank 1. Memory manager 330 performs this transfer of information, thus freeing up memory on Memory Banks 2, 4, and 5.

The information illustrated in FIG. 10, such as the quantity of memory banks 310 and the status of each memory bank 310, are provided as an example. In practice, embodiment 1000 may include additional information, less information, or different information than illustrated in FIG. 10.

Embodiments described herein may assist a CPU in determining when to power up a memory bank, how many memory banks to power up, and/or which memory banks to power up in order to optimize system performance and power consumption.

The foregoing disclosure provides illustration and description, but is not intended to be exhaustive or to limit the embodiments to the precise form disclosed. Modifications and variations are possible in light of the above disclosure or may be acquired from practice of the embodiments.

As used herein, the term “component” is intended to be broadly construed as hardware, firmware, or a combination of hardware and software.

Some embodiments are described herein in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “satisfying” a threshold (or similar terms) may be used interchangeably with “being greater than a threshold,” “being greater than or equal to a threshold,” “being less than a threshold,” “being less than or equal to a threshold,” or other similar terms.

It will be apparent that systems and/or methods, as described herein, may be implemented in many different forms of software, firmware, and hardware in the embodiments illustrated in the figures. The actual software code or specialized control hardware used to implement these systems and/or methods is not limiting of the embodiments. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of possible embodiments. In fact, many of these features may be combined in ways not specifically recited in the claims and/or disclosed in the specification. Although each dependent claim listed below may directly depend on only one claim, the disclosure of possible embodiments includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A method, comprising:
receiving, by a processor, an indication that a memory bank is to be powered up;
determining, by the processor and based on receiving the indication, a plurality of power scores corresponding to a plurality of powered down memory banks, each power score, of the plurality of power scores, corresponding to a power metric associated with powering up a powered down memory bank, of the plurality of powered down memory banks; and
powering up, by the processor, a selected memory bank, of the plurality of powered down memory banks, based on the plurality of power scores.

2. The method of claim 1, where the power metric is based on at least one of:
a power consumption associated with powering up the powered down memory bank;
an amount of time required to power up the powered down memory bank;
a quantity of errors reported by the powered down memory bank;
an amount of power consumed by the powered down memory bank;
a distance between the powered down memory bank and a component associated with the powered down memory bank;
a quantity of accesses to the powered down memory bank;
a quantity of memory blocks that are to be transferred to the powered down memory bank;
a quantity of memory blocks, stored in a powered up memory bank, that are native to the powered down memory bank; or
a predicted difference between a first quantity of non-native memory blocks stored in a first powered up memory bank, and a second quantity of non-native memory blocks stored in a second powered up memory bank, the predicted difference resulting from powering up the selected memory bank.

3. The method of claim 1, where the power metric is based on a difference between a value of a performance metric measured before powering up the selected memory bank, and an estimated value of the performance metric after powering up the selected memory bank.

4. The method of claim 1, where each power score is based on a set of power metrics associated with the plurality of powered down memory banks.

5. The method of claim 1, where receiving the indication is based on at least one of:
receiving an indication that an application or a process is to be launched by a system associated with the plurality of powered down memory banks;
receiving an indication receiving an indication that an application or a process has been launched by the system;
receiving an indication that powering up the selected memory bank will reduce power consumption of the system; or
receiving an indication that powering up the selected memory bank will increase performance of the system.

6. The method of claim 1, where receiving the indication is based on determining that a performance metric associated with a powered up memory bank satisfies a threshold, where the performance metric is based on at least one of:
a quantity of times that memory is evicted from the powered up memory bank;
a quantity of accesses to the powered up memory bank;
a quantity of memory misses associated with the powered up memory bank;
a quantity of memory blocks, included in the powered up memory bank, that include dirty information;
a quantity of memory blocks, included in the powered up memory bank, that include non-native information;
a quantity of memory blocks, included in the powered up memory bank, that include shared information; or
a quantity of memory blocks, included in the powered up memory bank, that include an instruction.

7. The method of claim 6, where the performance metric comprises an aggregate performance metric that is based on a set of performance metrics associated with a plurality of powered up memory banks.

8. A system, comprising:
one or more processors to:
receive an indication that a memory bank is to be powered up;
determine, based on receiving the indication, a plurality of power scores corresponding to a plurality of powered down memory banks, each power score, of the plurality of power scores, corresponding to a power metric associated with powering up a powered down memory bank, of the plurality of powered down memory banks; and
power up a selected memory bank, of the plurality of powered down memory banks, based on the plurality of power scores.

9. The system of claim 8, where the power metric is based on at least one of:
an amount of time required to power up the powered down memory bank;
a quantity of errors reported by the powered down memory bank;
an amount of power consumed by the powered down memory bank;
a distance between the powered down memory bank and a component associated with the powered down memory bank;
a quantity of accesses to the powered down memory bank;
a quantity of memory blocks that are to be transferred to the powered down memory bank;
a quantity of memory blocks, stored in a powered up memory bank, that are native to the powered down memory bank; or
a predicted difference between a first quantity of non-native memory blocks stored in a first powered up memory bank, and a second quantity of non-native memory blocks stored in a second powered up memory bank, the predicted difference resulting from powering up the selected memory bank.

10. The system of claim 8, where the power metric is based on a difference between a value of a performance metric measured before powering up the selected memory bank, and an estimated value of the performance metric after powering up the selected memory bank.

11. The system of claim 8, where each power score is based on a set of power metrics associated with the plurality of powered down memory banks.

12. The system of claim 8, where the one or more processors, when receiving the indication, are further to at least one of:
receive an indication that an application or a process is to be launched by a component associated with the plurality of powered down memory banks;
receive an indication receiving an indication that an application or a process has been launched by the component;
receive an indication that powering up the selected memory bank will reduce power consumption of the component; or
receive an indication that powering up the selected memory bank will increase performance of the component.

13. The system of claim 8, where the one or more processors, when receiving the indication, are further to:
receive the indication based on determining that a performance metric associated with a powered up memory bank satisfies a threshold, where the performance metric is based on at least one of:
a quantity of times that memory is evicted from the powered up memory bank;
a quantity of accesses to the powered up memory bank;
a quantity of memory misses associated with the powered up memory bank;
a quantity of memory blocks, included in the powered up memory bank, that include dirty information;
a quantity of memory blocks, included in the powered up memory bank, that include non-native information;
a quantity of memory blocks, included in the powered up memory bank, that include shared information; or
a quantity of memory blocks, included in the powered up memory bank, that include an instruction.

14. The system of claim 13, where the performance metric comprises an aggregate performance metric that is based on a set of performance metrics associated with a plurality of powered up memory banks.

15. A computer-readable medium storing instructions, the instructions comprising:
one or more instructions that, when executed by a processor, cause the processor to:
receive an indication that a memory bank is to be powered up;
determine, based on receiving the indication, a plurality of power scores corresponding to a plurality of powered down memory banks, each power score, of the plurality of power scores, corresponding to a power metric associated with powering up a powered down memory bank, of the plurality of powered down memory banks; and
power up a selected memory bank, of the plurality of powered down memory banks, based on the plurality of power scores.

16. The computer-readable medium of claim 15, where the power metric is based on at least one of:
an amount of time required to power up the powered down memory bank;
a quantity of errors reported by the powered down memory bank;
an amount of power consumed by the powered down memory bank;
a distance between the powered down memory bank and a component associated with the powered down memory bank;
a quantity of accesses to the powered down memory bank;
a quantity of memory blocks that are to be transferred to the powered down memory bank;
a quantity of memory blocks, stored in a powered up memory bank, that are native to the powered down memory bank; or
a predicted difference between a first quantity of non-native memory blocks stored in a first powered up memory bank, and a second quantity of non-native memory blocks stored in a second powered up memory bank, the predicted difference resulting from powering up the selected memory bank.

17. The computer-readable medium of claim 15, where the power metric is based on a difference between a value of a performance metric measured before powering up the selected memory bank, and an estimated value of the performance metric after powering up the selected memory bank.

18. The computer-readable medium of claim 15, where each power score is based on a set of power metrics associated with the plurality of powered down memory banks.

19. The computer-readable medium of claim 15, where the one or more instructions, that cause the processor to receive the indication, further cause the processor to at least one of:
receive an indication that an application or a process is to be launched by a component associated with the plurality of powered down memory banks;
receive an indication receiving an indication that an application or a process has been launched by the component;
receive an indication that powering up the selected memory bank will reduce power consumption of the component; or
receive an indication that powering up the selected memory bank will increase performance of the component.

20. The computer-readable medium of claim 15, where the one or more instructions, that cause the processor to receive the indication, further cause the processor to:
receive the indication based on determining that a performance metric associated with a powered up memory bank satisfies a threshold, where the performance metric is based on at least one of:
a quantity of times that memory is evicted from the powered up memory bank;
a quantity of accesses to the powered up memory bank;
a quantity of memory misses associated with the powered up memory bank;
a quantity of memory blocks, included in the powered up memory bank, that include dirty information;
a quantity of memory blocks, included in the powered up memory bank, that include non-native information;
a quantity of memory blocks, included in the powered up memory bank, that include shared information; or
a quantity of memory blocks, included in the powered up memory bank, that include an instruction.
